(19) United States
(12) Patent Application Publication
(10) Pub. No.: US 2020/0405078 A1
(43) Pub. Date: Dec. 31, 2020

(54) INTERACTIVE PRODUCT DISPLAY

(71) Applicant: Walmart Apollo, LLC, Bentonville, AR (US)

(72) Inventors: James Martin, Bethel Heights, AR (US); Allyson Hawkins, Bentonville, AR (US)

(21) Appl. No.: 16/886,597

(22) Filed: May 28, 2020

Related U.S. Application Data
(60) Provisional application No. 62/868,646, filed on Jun. 28, 2019.

(51) Int. Cl. A47F 7/30; A47F 5/00; A47F 5/025

(52) U.S. Cl. CPC A47F 7/30; B60N 2/28; A47F 5/025; A47F 5/0068

(57) ABSTRACT

Examples of the disclosure provide systems and methods for interactively displaying a product on a show room floor. The interactive display allows a customer to practice using and installing the actual product in a simulated environment, which helps the customer determine whether the product is right for their needs and desires. In examples, the interactive display includes a rotatable platform attached to an extendable arm. A product may be secured to the rotatable platform, and the rotatable platform may rotate to provide 360 degrees view of the product. A use may pull the product away from the display and toward themselves due to the extendable arm which supports the weight of the rotatable platform and the product while the arm is in an extended position, while the arm is in a contracted position, and while the arm transitions between the extended and contracted position. While the extendable arm is in an extended position, if a user releases the product, the extendable arm may automatically contract into a stead state contracted position.

### BACKGROUND

Many businesses display sellable products in a showroom. Traditionally, products are displayed on shelves allowing a customer to take the product off a display self and present the product at a point of sale for purchase. Some products are packaged in a box in a manner that encourages retailers to place the packaged version of the product on a display shelf, so that a customer can easily transport the packaged product from the self a point of sale for purchase without damaging or misplacing any components of the packaged product. Some retailers display a version of a packaged product outside its packaging to allow a consumer to view and touch an example of the product.

### SUMMARY

Examples of the disclosure provide systems and methods for interactively displaying a product including a rotatable platform that comprises a mounting mechanism that removably secures at least one product being displayed by the rotatable platform and a rotator that rotates the rotatable platform. The example systems and methods further include at least one extendable arm that comprises at least one fastener that couples the extendable arm to the display shelving system and at least one fastener that couples the rotatable platform to the extendable arm in a configuration that allows the rotatable platform to rotate while coupled to the extendable arm. The example systems and methods further include at least one transitioning joint configured to allow the extendable arm to transition between a contracted position and an extended position, in response to a manual pull on the coupled rotatable platform. Further, the example systems and methods further include at least one transitioning joint configured to at least one transitioning joint configured to automatically transition the extendable arm between the extended position and the contracted position, in response to a manual release of the coupled rotatable platform.

The Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is an exemplary diagram illustrating an example product display platform.

FIG. 2 is an exemplary diagram illustrating an example product display platform.

FIG. 3 is an exemplary diagram illustrating an example product display platform

FIG. 4 is an exemplary diagram illustrating an example product display configuration.

FIG. 5 is an exemplary diagram illustrating an example product display configuration.

FIG. 6 is an exemplary diagram illustrating an example product display configuration.

FIG. 7 is an exemplary diagram illustrating an example product display configuration.

FIG. 8 is an exemplary flow diagram illustrating example operations performed by systems described herein.

FIG. 9 is an exemplary diagram including a block diagram of some features illustrating an example product display configuration.

FIG. 10 is an exemplary diagram illustrating example operations performed by systems described herein.

FIG. 11 is an exemplary flow diagram illustrating example operations performed by systems described herein.

Corresponding reference characters indicate corresponding parts throughout the drawings.

### DETAILED DESCRIPTION

Aspects of the disclosure enable exhibition or retail locations to display a product in various simulated intended use environments. Traditional product display configurations often allow a consumer to view and touch a product; however, the consumer is unable to interact with the product in a meaningful way without first purchasing the product and transporting the purchased product to an intended use environment. Example product display configurations and example product display platforms, described herein, allow consumers to interact with a product in a simulated intended use environment prior to purchase, while the product remains within an exhibition or retail location or within the product display configuration.

However, some products involve complicated installations and may be intended to integrate with products a customer already owns. Customers may have difficulty envisioning such installation and integration issues in a showroom. An inability to adequately interact with a product in its intended environment leads to customer frustration because products may be purchased without a full understanding of how the product will perform in everyday use an/or integrate with products the user already owns.

For example, a traditional car seat product display may allow a customer to view a car seat and touch the fabric, but the customer is unable to simulate interacting with the car seat in its intended use environment (e.g., in a vehicle, carrying the seat, storing the seat, attaching accessories with accessories, and the like). Systems and methods described herein provide an interactive product display, which may be used for child safety seat products (e.g., child and/or infant car seats, child and/or adults booster seats, and the like). For example, the interactive product display may simulate a product's functionality, such as the functionality of a child safety seat, in various intended use environments, such as in a vehicle, in a shopping cart, attached to a stroller, and more. An interactive car seat display shelving system includes product display configurations and platforms that allow a customer to simulate installing and uninstalling a displayed car seat by latching and unlatching the car seat's latches to simulated vehicle anchors. Additionally, and/or alternatively, product display configurations and platforms allow a customer to simulate installing and uninstalling a car seat by securing a vehicle seat belt system through openings of a displayed car seat. Providing this life-like user experience for the customer may help the customer decide which car seat they prefer based on the ease or difficulty of installation.

Simulating the car seat experience provides the customer freedom to manipulate a fully assembled, unpackaged car seat and encounter experiences and/or sensations that may affect their selection, for example, weight, grip, size, cumbersomeness, shopping cart compatibility, stroller attachment compatibility, jogger attachment compatibility, charging attachment compatibility, mobile device attachment compatibility, accessory attachment compatibility, and the like. Further, providing a customer with real-life experiences gives context to product descriptions and/or reveals sensations that may be missing from a product description.

For example, a car seat may be heavy and/or light, depending on the strength of the person interacting with the car seat, thereby giving more meaning to a product weight listed in a product description. A car seat may be described as including an ergonomic handle, but the description may lack context until a customer experiences the comfort and easy of using the handle. The interactive product display configuration may allow a customer to walk around while holding the seat, which may reveal that the car seat is well configured for the customer's lift thresholds and arm length. Further, the existence of a selling feature of the product (e.g., an easy release base button) may be included in a product description, however; the real-world effect of product size, weight, design, configuration, and so forth relative to an individual consumer will vary from person to person depending on each individual's unique characteristics.

With an interactive display configuration, a customer may determine whether the car seat pinches, pokes, scratches, or is otherwise uncomfortable. The customer may buckle and unbuckle the restraints of the car seat. Some customers may want the restraints to be too difficult for the car seat user (e.g., child) to remove while other customers may prefer that the car seat user be able to buckle and unbuckle themselves with or without help because the car seat user is mature enough to perform the operation (e.g., an adult, a five year old child, and/or the like).

In examples, a customer may interact with an infant seat system's functionality. An infant car seat system typically includes a base, a detachable seat, and one or more optional attachable accessories (e.g., for incorporation of the car seat with a stroller). Traditionally, the base installs semi-permanently onto the backseat of a vehicle via latches that latch to anchors of the vehicle. Additionally, and/or alternatively, the base installs semi-permanently via openings through which a vehicle safety belt threads prior to the safety belt restraint's tongue connecting to a corresponding buckle of the vehicle's safety belt restraint system. Often, the infant safety seat is detachable from the base. Enabling physical interaction with the tangible product provides for better understanding of these design aspects to determine which infant seat system is preferred. A customer may practice physically attaching and detaching an infant seat from a base that is mounted to product display platform. Further, a customer may practice installing and uninstalling the base from a vehicle using a platform simulated vehicle car seat anchors and/or a simulated vehicle seat belt system (e.g., a three-point lap and shoulder belt system).

Some product display configurations may allow a seat and/or base to travel a distance from its display platform, if desired, allowing for further interaction. A customer may detach an infant seat from its base to carry the infant car seat and appreciate its weight and design features, or practice attaching the infant car seat to compatible accessories, including but not limited to strollers, joggers, gliders, dollies, and/or the like. A customer may practice resting the infant seat on a shopping basket and/or wagon. Further still, a customer may practice attaching accessories to the infant seat, for example, buntings, canopies, rain shields, seat protectors, head supports, strap covers, infant mobiles, child activity centers, computer devices, mirrors, and the like. If desired, a customer may practice storing the infant seat and/or base in travel bags and/or backpacks.

An interactive product display configuration may be within an exhibition location (e.g., retail store or booth, wholesale store or booth, convention center, exhibit hall, manufacturing facility, and the like) to display a product. Example interactive product display configurations include store shelving units, endcap displays, checkout lane displays, and/or floor features. An endcap display is a display of products on an endcap of a store shelving unit. A checkout lane display is a display of products located adjacent to or associated with a checkout lane of a store. A floor feature is an additional display of products, typically set in a temporary location, in an effort to draw additional attention to a featured product.

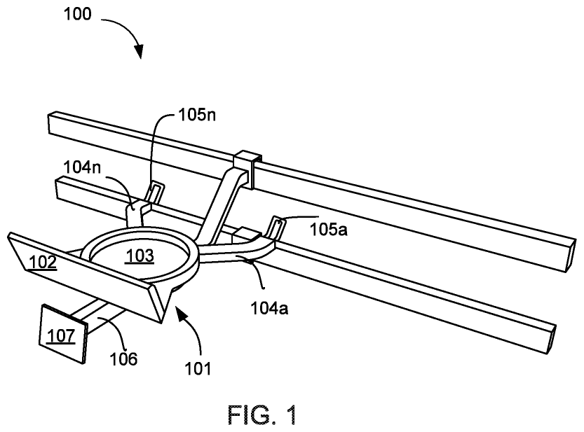

FIG. 1 illustrates an example interactive product display configuration 100 that includes a rotatable platform 101 as shown from an aerial perspective without a product resting thereon. Platform 101 may include an optional barricade 102 that maintains a product in place the platform 101. Barricade 102 may be one or more of a bar, barrier, block, fence, screen, panel, and/or the like. Barricade 102 may be configured to couple to a product and/or may provide a non-coupled blocking mechanism for a product. Barricade 102 is shown as providing a frontal blockade and may optionally provide one or more of a frontal, side, rear, top and/or bottom blockade. Barricade 102 is shown as being rectangular in shape but may be of any shape. Barricade 102 may be an integral portion of platform 101 or be modularly attached to platform 101. Example attachment mechanisms that may attach barricade 102 to platform 101 include screws, fasteners, magnets, latches, bolts, buckles, buttons, catches, clasps, locks, rivets, slides, receivers, sleeves, snaps, hangers, hooks, mounting plates, pegs, retractable pegs, flanges, brackets, and the like.

Platform 101 may include a platform base 103 configured to support one or more products resting thereon. In examples, while in steady state, platform base 103 may face the sky. Platform base 103 may be shaped and sized to correspond with the bottom of a specific product and/or be shaped to support a variety of products. In some examples, platform base 103 may include indentions that inversely correspond to at least a portion of the bottom of one or more specific products, wherein the indentions removably secure a product to the platform 101. Example platform base 103 is shown as being substantially circular, however platform base 103 may be any desirable shape.

Extensions 104a-104n extend from platform base 103 providing further surface upon which a product may rest. An extension 104 may be one or more of an arm, bar, rod, beam, panel, plate, sheet, terrace, and/or the like. Extensions 104a-104n may be an integral portion of platform base 103 or be modularly attached to platform base 103. Example attachment mechanisms that may attach extensions 104a-104n to platform base 103 include screws, fasteners, magnets, latches, bolts, buckles, buttons, catches, clasps, locks, rivets, slides, receivers, sleeves, snaps, hangers, hooks, mounting plates, pegs, retractable pegs, flanges, brackets, and the like. Extensions 104a-104n may be of variable lengths, widths, shapes, and sizes.

Extensions 104a-104n may support anchors 105a-105n. Anchors 105a-105n may be configured to simulate the vehicle anchors of a child seat latching system. Example anchor 105a may be a “U” shaped receiving mechanism made of resilient material (e.g., metal, plastic, and the like) configured to receive a latch. Example anchors may be of any shape and size (e.g., a hook, bar, eye hole, rectangular shape, horseshoe shaped oval shaped, circle shaped, elongated shaped, and the like) extension from the platform base 103 and/or extension 104. Anchors 105a-105n may be an integral portion of an extension 104 or be modularly attached to an extension 104. Example attachment mechanisms that may attach anchors 105a-105n to extensions 104a-104n include screws, fasteners, magnets, latches, bolts, buckles, buttons, catches, clasps, locks, rivets, slides, receivers, sleeves, snaps, hangers, hooks, mounting plates, pegs, retractable pegs, flanges, brackets, and the like.

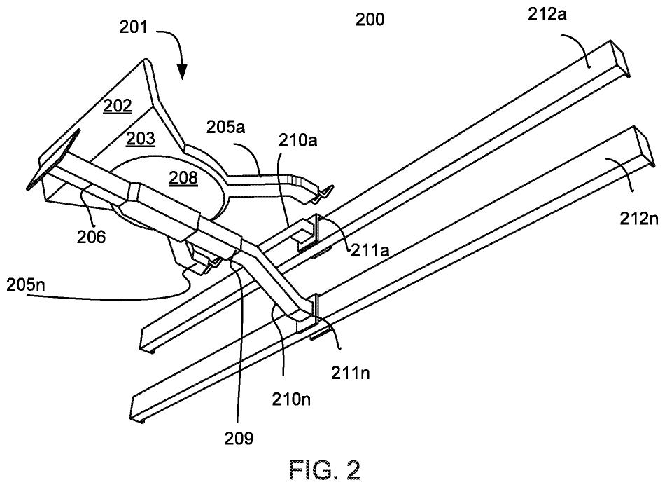

An underside (not shown) of platform base 103 may modularly attach via an attachment mechanism (examples of which are provided above) to arm 106 or may be an integral portion of arm 106. Further details regarding arm 106 and attaching platform 101 to arm 106 are described below in the description of FIG. 2, which illustrates a platform 201 is shown from underneath. One or more label displays 107 may modularly attach to arm 106 or be an integral portion of arm 106. A label display 107 may support a label (e.g., an indicium, magnet, electronic ink display, RFID, and/or any other suitable type of label) to assist in identifying a product resting on platform 101. A label may include a computer scannable portion. Scanning may collect data including images, barcodes, Universal Product Code (UPC) data, optical character recognition (OCR) text information, RFID data, and the like using one or more sensor device described herein.

In examples, platform base 103 and extensions 104a-104n may be sized and shaped to support a child safety seat resting thereon. Anchors 105a-105n be configured to receive latches of a child safety seat product coupling the child safety seat to platform 101 and/or providing for physical interaction with the latching mechanism of a child safety seat.

FIG. 2 illustrates a portion of an example product display configuration 200. In this example, platform 201 is shown from underneath and corresponds with platform 101 of FIG. 1, which may be a rotatable platform 201 as shown in FIG. 2. Rotatable platform 201 includes rotating mechanism 208 allowing platform base 203 to rotate any number if degrees from zero to 360 degrees, in a plane parallel to arm 206. Examples of a rotating mechanism 208 may be one or more of, but is not limited to, a hinge, pivot hinges, roto hinges, swivel plates, revolving plates, spinners, turntables, lazy Susan's, ball bearing swivels, spinners, automatic return rotation plates, and/or the like. A rotating mechanism 208 may be selectably configurable to rotate a selected number of degrees (e.g., 90 degrees, 180 degrees, and the like). Rotating mechanism 208 may have a steady state position causing platform base 203 automatically to return to a steady state position upon release. An example steady state position may be set such that barricade 202 faces a customer and anchors 205a-205n face away from the customer. Steady state may be considered a zero-degree rotation or a near zero-degree rotation.

A customer may manually rotate the platform base 203 any number of degrees, and upon the customer releasing the platform base 203, rotating mechanism 208 may automatically rotate (e.g., in the reverse direction) until it reaches its steady state position at 0 degrees or near zero degrees (e.g., causing barricade 202 to rest in a position that faces the customer). The steady state position of rotating mechanism 208 may be configurable such that a user (e.g., retailer) may select the steady state position of platform base 203. In examples, rotating mechanism 208 may be configured such that the steady state is set at 0 degrees, 45 degrees, 90 degrees, 135 degrees, and so on. In examples, rotating mechanism 208 may be configured such that the steady state is set at displays a front, side, back, and/or any viewing angle of rotatable platform 201. Rotating mechanism 208 may be modularly attached to or integrated with platform base 203.

Rotatable platform 201 may include a pivot mechanism (not shown) allowing platform base 203 to pivot one to 360 degrees, or more, in a plane perpendicular to arm 206. Examples of a pivot mechanism may be one or more of, but is not limited to, spinners, pivot hinges, roto hinges, swivel plates, revolving plates, turntables, lazy Susan's, ball bearing swivels, automatic return rotation plates, and/or the like. Pivot mechanism may have a steady state position causing the platform base 203 to return to a steady state position upon release. An example steady state position may be set such that rotating mechanism 208 faces the floor and anchors 205a-205n rise vertically toward the sky. Steady state may be considered a 0 degrees rotation or near zero degrees rotation. In examples, rotating mechanism 208 may be configured such that the steady state is set at 0 degrees, 45 degrees, 90 degrees, 135 degrees, and so on. Further, pivot mechanism may be configured such that its steady state displays a top, side, bottom, and/or any viewing angle of rotatable platform 201. Pivot mechanism may be modularly attached to or integrated with platform base 203.

Platform base 203, rotating mechanism 208, or pivot mechanism (not shown) of rotatable platform 201 may be integrated with arm 206 or may be modularly attached thereto. Example attachment mechanisms that may attach rotatable platform 201 to arm 206 include rotating mechanism 208, pivot mechanism, screws, fasteners, magnets, latches, bolts, buckles, buttons, catches, clasps, locks, rivets, slides, receivers, sleeves, snaps, hangers, hooks, mounting plates, pegs, retractable pegs, flanges, brackets, and the like.

Arm 206 may be an extendable arm 206 having an extendable mechanism 209 that transitions between contracted and extended positions. Examples of an extendable mechanism 209 may include one or more extendable joints including, but are not limited to, telescoping arms, sliding receivers and connectors, rack rails, manual and/or automatic cranks, shocks, gas shocks, springs, hydraulic extenders, hydraulic cylinders, gas and/or air extenders, gas and/or air cylinders, rowing extenders, scissor extenders, articulating extenders, folding extenders, butterfly extenders, pop out extenders, and/or the like.

Extendable mechanism 209 may extend and contract or retract in response to an external force moving the rotatable platform 201 in a direction that is parallel to extendable arm 206. In examples, extendable mechanism 209 may manually extend and automatically contract or retract. Additionally, extendable mechanism 209 may automatically and/or manually extend and automatically and/or manually contract or retract. Extendable mechanism 209 may have a steady state position (e.g., position zero). Extendable mechanism 209 may automatically maintain the steady state position in the absence an external force, allow an external force to cause deviation from the steady state position, and automatically return to the steady state position upon the release of the external force. The steady state position may be selectable. The selected steady state position may be selectably configured to maintain the extendable arm 206 in a contracted position, an extended position, or a desired position therebetween in the absence of an external force.

In examples, the steady state position of extendable mechanism 209 is the contracted position of extendable arm 206. Upon a customer manually pulling the rotatable platform 201 that is attached to the extendable arm 206, the extendable mechanism 209 allows the extendable arm 206 to transition from the contracted position into an extended position or a point therebetween. Upon the customer releasing the rotatable platform 201, the customer provided external force is removed, and the extendable mechanism 209 automatically retracts, which automatically transitions the extendable arm 206 from the extended position and the contracted position until it reaches its steady state position. In examples, an external force (e.g., a customer) may assist the extendable mechanism 209 return to steady state (e.g., push the rotatable platform 201 that is attached to the extendable arm 206 towards the steady state position).

In examples, a static arm may be modular such that one or more extendable mechanisms 209 may be attached thereto via one or more attachment mechanisms, for example, one or more screws, fasteners, magnets, latches, bolts, buckles, buttons, catches, clasps, locks, rivets, slides, receivers, sleeves, snaps, retractable pegs, pegs, brackets, and the like. Attaching one or more extendable mechanisms 209 to a static arm cause the arm to become an example extendable arm 206. Alternatively, one or more of extendable mechanism 209 may be an integrated portion of extendable arm 206. Additionally, one or more additional extendable mechanisms 209 may be modularly added to an extendable arm 206 via one or more attachment mechanisms, as described above.

Extendable arm 206 may include one or more arm portions 210a-210n that may be integral portions of extendable arm 206. Additionally or alternatively, extendable arm 206 may be modular such that one or more arm portions 210a-210n may be attached thereto via one or more attachment mechanisms, for example, one or more screws, fasteners, magnets, latches, bolts, buckles, buttons, catches, clasps, locks, rivets, slides, receivers, sleeves, snaps, retractable pegs, brackets, and the like. Example product display configuration 200 illustrates an example where arm portions 210a-210n form a “Y” shape, but one or more arm portions 210a-210n may form any desired shape. Variable shapes formed by arm portions 210a-210n may provide varied load bearing capacity, varied coupling points, consume a varied amount of materials to create, and a desired shape may be selected and/or modular configured based on characteristics of a product being displayed on rotatable platform 201 (e.g., weight, size, height, and the like).

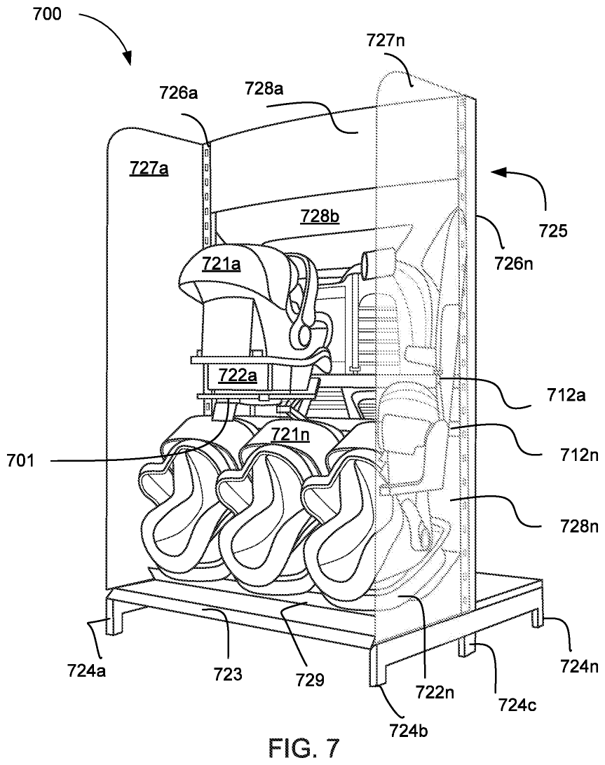

An example arm portion 210 includes a one or more coupling mechanisms 211a-211n that attach to one or more crossbars 212a-212n. Details of crossbars 212a-212n are described by way of example below at least in FIG. 7. In examples, coupling mechanisms 211a-211n may include one or more of hangers, hooks, flanges, screws, fasteners, magnets, latches, bolts, buckles, buttons, catches, clasps, locks, rivets, slides, receivers, sleeves, snaps, retractable pegs, brackets, and the like. If desired, one or more coupling mechanism 211a-211n may secure to one or more crossbars 212a-212n in a locked state via one or more locking mechanism (not shown) for example a screw, fastener, latch, bolt, buckle, button, catch, clasp, lock, rivet, peg, retractable peg, snap, and the like. While in an unlocked state, coupling mechanism 211a-211n may side across crossbars 212a-212n to adjust the display configuration. Further, while in an unlocked state, coupling mechanism 211a-211n may lift on and off crossbars 212a-212n to adjust the display configuration.

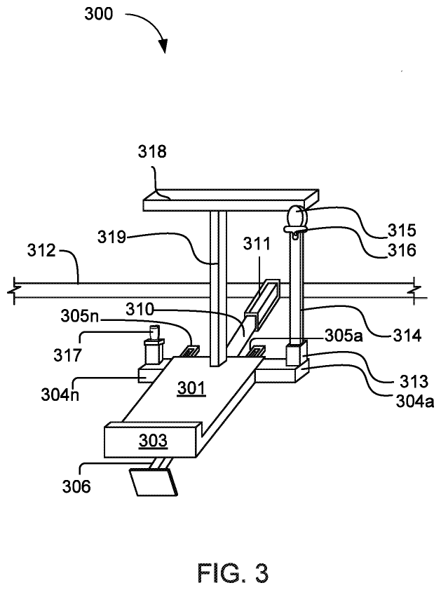

FIG. 3 illustrates a portion of an example product display configuration 300. In this example, rotatable platform 301 is shown from an aerial perspective without a product resting thereon. Example rotatable platform 301 is shown as having a rectangular platform base 303, but platform base 303 may be of any shape. Example product display configuration is shown having extendable arm 306 having one arm portion 310 that is a slot which attaches to crossbar 312 via coupling mechanism 311 that is a receiver in this example.

In examples, extensions 304a-304n may extend from platform base 303 providing further area for integrated features of the platform and/or further area for the coupling of modular features of the platform. An extension 304 may be one or more of an arm, bar, rod, beam, panel, plate, sheet, terrace, and the like. Extensions 304a-304n may modularly attached to platform base 303 (via one or more coupling mechanism described above) or may be an integral portion of platform base 303. Extensions 304a-304n may be of variable lengths, widths, shapes, and sizes. In examples, extensions 304a-304n and/or platform base 303 itself may support one or more anchors 305a-305n modularly coupled thereto (via one or more coupling mechanism described above) and/or integrated therewith.

Rotatable platform 301 includes components of a seat belt system. The seat belt system may simulate a vehicle seat belt system. A seat belt system may include retractor 313, which may have a housing and a mechanism to control the tautness of retractable webbing 314 (e.g., via a winding mechanism). Retractor 313 may attach to extension 304a (via one or more coupling mechanism described above) or be an integral portion thereon. Retractable webbing 314 may extend out from retractor 313 and thread through a loop 315 (e.g., pillar loop) that may be supported at a position above platform base 303. The retractable webbing 314 may also thread through a portion of a tongue 316. The seat belt system may also include buckle 317 that may be modularly attached to platform base 303 or extension 304 via one or more coupling mechanism as described above. In examples, buckle 317 may be an integral portion of extension 304n or platform base 303. Buckle 317 may correspond to tongue 316, such that buckle 317 secures tongue upon insertion and releases tongue upon actuation of a releasing mechanism (e.g., button, lever, or the like). Any portion of the seat belt system may be modularly attached to rotatable platform 301 (via one or more coupling mechanism described above) and/or integrated therewith.

In examples, loop 315 may be supported by crossarm 318 that is supported by example pillar 319 that extends upwards from platform base 303. Example pillars 319 and crossarms 318 may include cantilevers, joists, snap rails, brackets, braces, crossbars, shelves, platforms, and the like. In examples, crossarm 318 may be omitted and loop 315 may be supported by a pillar (not shown) that extends upwards from a right or left side of platform base 303 and/or extensions 304a-304n. In further examples, pillar 319, crossarm 318, and/or pillar (not shown) support a panel (not shown) and/or other backing that simulates the backrest of a vehicle's seat. Further, one or more anchors (not shown) may couple to pillar 319, crossarm 318, additional pillar (not shown), platform floor 303, and/or extensions 304a-304n to simulate vehicle car seat anchors located on a vehicle's a ceiling or frame, rear shelf (e.g., sedan), back wall (e.g., truck), back of a vehicle seat (e.g., sports utility vehicle van, station wagon, hatchback), and/or cargo floor (e.g., sports utility vehicle van, station wagon, hatchback). Pillar 319, crossarm 318, additional pillars (not shown) anchors, and backings may be modularly coupled to rotatable platform 301 (via one or more coupling mechanism described above) and/or integrated therewith.

In examples, a customer may use the seat belt system of rotatable platform 301 to interact with a product. For example, if rotatable platform 301 displays a car seat, a customer may use the rotatable platform's seat belt to practice the experience of securing the car seat to the back seat of a vehicle using a vehicle seat belt. Such a real-life experience may encourage the customer to purchase a particular car seat.

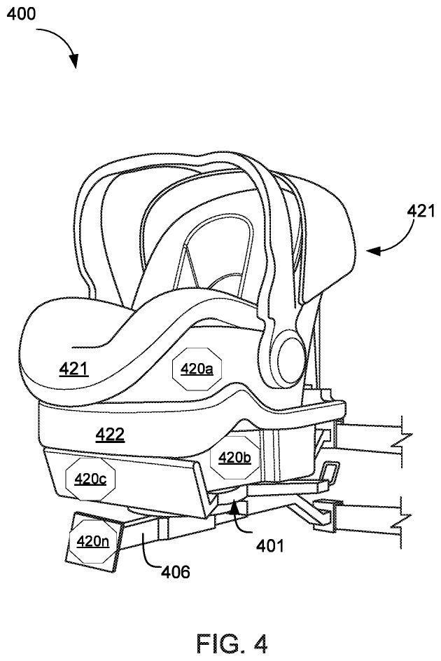

FIG. 4 illustrates an example of a portion of example product display configuration 400. In this example, product 421 and corresponding product 422 are displayed on rotatable platform 401. Rotatable platform 401 may attach to extendable arm 406.

In examples, product display configuration 400, rotatable platform 401, product 421, and/or corresponding product 422 may include one or more security mechanisms that deters theft. For example, rotatable platform 401 and/or any portion of product display configuration 400 may include a security leash (not shown), for example, one or more cables, chains, ropes, magnets, and the like, that locks product 421 and/or corresponding product 422 within an area, enabling product 421 and/or corresponding product 422 to be removed from rotatable platform 401 but preventing product 421 and/or corresponding product 422 from traveling more than x distance away from the rotatable platform 401, wherein x is less than or equal to the length of the security leash. A security leash may be retractable into a housing by a winding mechanism.

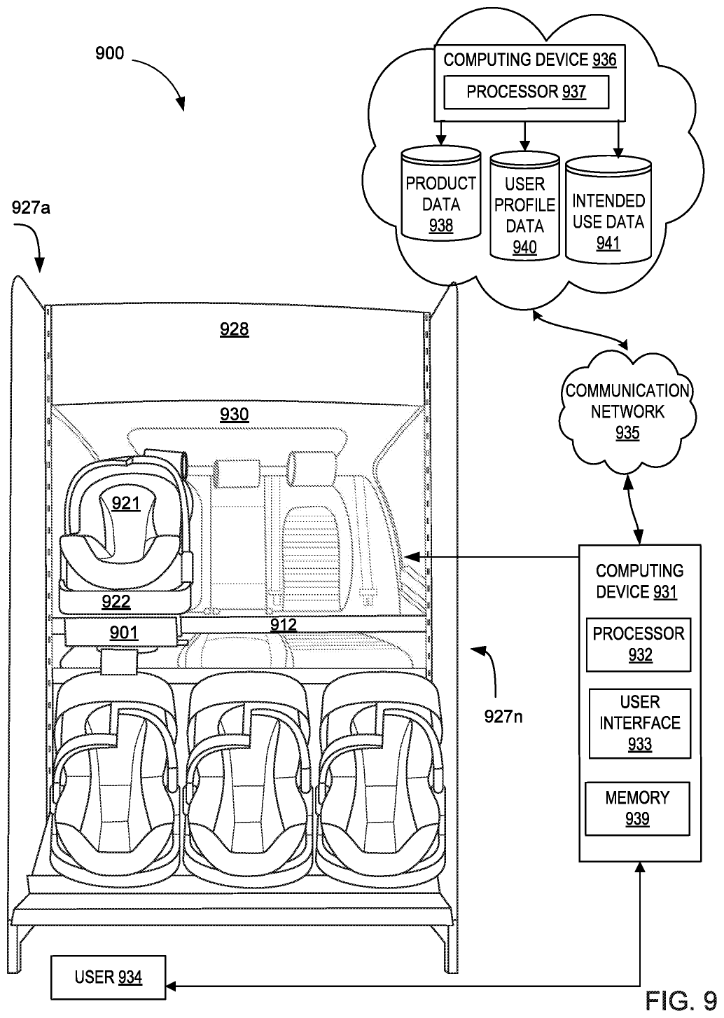

Additionally, and/or alternatively, rotatable platform 401 and/or portion any of product display configuration 400 may include one or more proximity sensor in communication with a processor (as shown in FIG. 9) that determines the proximity of product 421 and/or corresponding product 422. A proximity sensor may be configured to trigger an alarm, locally and/or remotely, upon product 421 and/or corresponding product 422 traveling y distance away from the proximity sensor, platform, and/or portion any of product display configuration 400. In examples, y may be variable and defined by a user (e.g., retailer via a user interface). In examples, y may be defined as being a distance that permits a customer to remove product 421 and/or corresponding product 422 from rotatable platform 401 and interact with product 421 and/or corresponding product 422 while removed but prevents product 421 and/or corresponding product 422 from traveling more than a few feet, steps, and/or yards away from rotatable platform 401 and/or any portion of product display configuration 400. The value y may be defined as being any desirable distance. One or more alarms 420a-420n may be observed visually, audibly, and/or physically (e.g., tactile output). The alarms 420a-420n may couple to one or more of product 421, corresponding product 422, rotatable platform 401, product display configuration 400, remote display, remote computer, a mobile device, and the like. The proximity sensor may be configured to trigger a locking mechanism on product 421 and/or infant base 422 that prevents product 421 and/or corresponding product 422 from functioning properly (e.g., prevents compatibility between product 421 and corresponding product 422), prevents installation of product 421 in its intended use environment, prevents use of features of the product 421 and/or corresponding product 422, prevents product 421 and/or corresponding product 422 from traveling further from rotatable platform 401 and/or product 421 and/or corresponding product 422 from exiting an area.

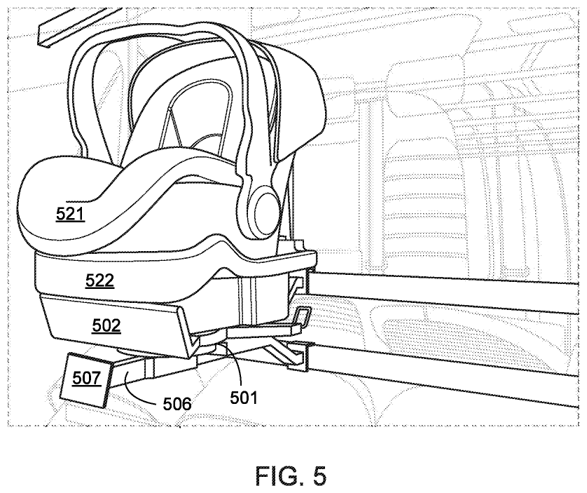

FIG. 5 illustrates an example of a portion of example product display configuration. In this example, an infant seat system, or child safety seat system, is displayed. In this illustrative example, infant seat system includes infant seat 521 and corresponding infant base 522, which rests on rotatable platform 501. Rotatable platform 501 includes barricade 502 may be configured to couple to infant base 522 and/or may provide a non-coupled blocking mechanism for a product. Example coupling mechanisms that may couple infant base 522 to barricade 502 include hook and loop fasteners, other fasteners, magnets, catches, rivets, snaps, pegs, retractable pegs, flanges, protrusions, and the like. Rotatable platform 501 may attach to extendable arm 506. Extendable arm 506 may include label display 507 that displays product information about infant seat 521 and/or corresponding infant base 522.

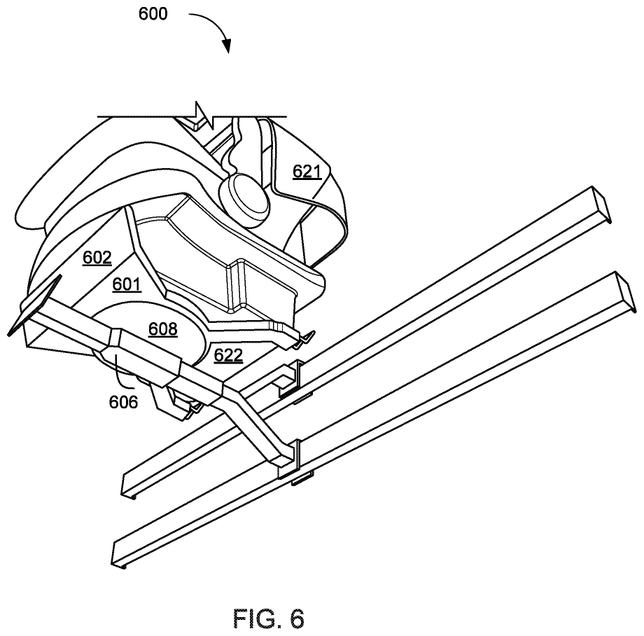

FIG. 6 illustrates an example of a portion of example product display configuration 600 as seen from underneath. In this example, an infant seat system is displayed. Infant seat system includes infant seat 621 and corresponding infant base 622, which rests on rotatable platform 601. Rotatable platform 601 includes barricade 602 may be configured to couple to infant base 622 and/or may provide a non-coupled blocking mechanism for a product. Rotatable platform 601 also include rotating mechanism 608. Rotatable platform 601 attaches to extendable arm 606 by any attachment mechanism disclosed herein.

FIG. 7 illustrates an example interactive display configuration 700 may include a base 723, which in examples is a load bearing base. Base 723 may include feet 724a-724n, which may be attach to base 723 via an attachment mechanism or may be an integral portion of base 723. Feet 724a-724n may be adjustable an effect the height of base 723.

Attached to base 723 via an attachment mechanism is a vertically extending load bearing back 725. Load bearing back 725 distributes weight to a plurality of vertical posts 726a-726n that extend in a vertical direction from base 723. Examples vertical posts may include posts, pedestals, buttresses, masts, piers, pilasters, pilings, props, shafts, vertical supports, uprights, and the like. In examples, at least one post 726n extends to the ground and functions as a foot 724c.

One or more vertical posts 726a-726n may include one or more weight bearing receiving mechanisms, for example, slots, holes, grooves, magnets, catches, and the like. Example vertical posts 726a-726n are illustrated as being slotted, wherein a slot is configured to receive a protrusion (e.g., flanges, pegs, retractable pegs, screws, and the like). In example configurations, a receiving mechanism may be attached (via an attachment mechanism described above) to a vertical post 726, for example a vertical track beam having receiving features (e.g., slots, holes, grooves, magnets, catches, and the like) that receive protrusions (e.g., flanges, pegs, retractable pegs, screws, and the like). In example interactive display configuration 700, slotted vertical posts 726a-726n are shown near the right and left edges of load bearing back 725; however, posts 726a-726n may be located in any vertical position of load bearing back 725.

Load bearing back 725 may also include one or more back panels 728a-728n. In some examples, back panels 728a-728n extend horizontally between vertical posts 726a-726n and attach thereto via one or more of the attaching mechanisms and/or via protrusions extending into receiving mechanisms as described herein. In other examples, back panels 728a-728n maybe coupled to, affixed, or otherwise integrated into load bearing back 725. Back panels 728a-728n may be communicatively coupled and/or controlled by a processor to display information. In some examples, back panel 728a displays product information and/or marketing information, back panel 728b displays a simulation of an interior of a backseat of a vehicle, and back panel 728n displays other information. An example load-bearing back 725 (not shown) may include additional receiving mechanisms (not shown), for example, peg boards, slotted wall panels, and the like, which receive protrusions (e.g., flanges, pegs, retractable pegs, magnets, and the like) but support and distribute less weight as compared to weight bearing receiving mechanisms. An example load bearing back 725 that includes additional receiving mechanisms may have information and/or images printed thereon and/or coupled thereto, including product information, marketing information, and images simulating an intended use environment (e.g., stroller attachments).

Interactive display configuration 700 may include one or more side panels 727a-727n. A side panel 727a may attach to a vertical post 726a via one or more of the attaching mechanisms described herein and/or via protrusions extending into receiving mechanisms as described herein. In examples, portions of side panels 727a-727n may display product information and/or marketing information, portions of side panels 727a-727n may display a simulation of an intended environment for the physical product being displayed, such as an interior of a backseat of a vehicle, and portions of side panels 727a-727n may display a solid color or other information.

Any number of horizontal support mechanisms 712a-712n may extend between one or more load bearing slotted vertical posts 726a-726n. Example horizontal support mechanisms 712a-712n include cantilevers, joists, snap rails, brackets, braces, crossbars, shelves, and/or the like. In example interactive display configuration 700, crossbars 712a-712n couple to slotted vertical posts 726a-726n via protrusions that extend out from crossbars 712a-712n and into slots of the slotted vertical posts 726a-726n. Further, attachment mechanisms may further couple and/or secure crossbars 712a-712n to slotted vertical posts 726a-726n, for example, one or more screws, fasteners, magnets, latches, bolts, buckles, buttons, catches, clasps, locks, rivets, slides, receivers, sleeves, snaps, retractable pegs, brackets, and the like.

Example interactive display configuration may also include shelves, ledges, counters, racks, receptacles, and the like. Example interactive display configuration 700 includes an example shelf 729 that is slanted at an angle and configured to display one or more products 721b-721n and 722b-722n. In examples, one or more products 721b-721n and 722b-722n may be alternative versions of products 721a and 722a (e.g., alternative colors, shapes, and/or sizes). In examples, shelf 729 may include protrusions (e.g., flanges, pegs, retractable pegs, magnets, and the like) extending out from shelf 729 and into receiving features (e.g., slots, holes, grooves, magnets, catches, and the like) of a receiving mechanism (e.g., slotted vertical posts 726a-726n, track beams (not shown), peg boards, slotted wall panels, and the like). In examples, shelf 729 may attach to one or more brackets (not shown) via an attachment mechanism described herein, and the one or more brackets may include protrusions (e.g., flanges, pegs, retractable pegs, magnets, and the like) extending out from shelf 729 and into receiving features (e.g., slots, holes, grooves, magnets, catches, and the like) of a receiving mechanism (e.g., slotted vertical posts 726a-726n, track beams (not shown), peg boards, slotted wall panels, and the like).

One or more products 721a and 722a may be displayed in a portion of product display configuration 700, for example at or around a height similar to an average consumer's eye level. In examples, one or more products 721a and 722a may rest on a rotatable platform 701 that attaches to one or more extendable arms (not shown), which attach to one or more crossbars 712a-712n. In examples, rotatable platform 701 may be configured to cause one or more products 721a and 722a to appear to be floating within product display configuration 700. In examples, rotatable platform 701 may be configured to cause one or more products 721a and 722a to appear to be installed within the interior of a vehicle. Example product display configurations may be configured with any number of rotatable platforms 701 attached to any number of extendable arms (not shown) attached to any number of crossbars 712a-712n. Further, the various rotatable platforms 701 may be positioned at any height and varying heights, the steady state positions of a plurality of rotatable platforms 701 may be configured an any position and varying positions. Further still, the steady state positions of a plurality of extendable arms (not shown) may be configured an any position and varying positions.

Any number and variety of products may be displayed in various sections of interactive product display configuration 700, for example on any number of shelves 729. Further, product display configurations are not limited with regard to the number of sections but are configurable to include any number of sections, for example, top, bottom, center, middle, right, and left sections.

In examples, an exhibit location may include walking spaces (e.g., aisles) that are formed by rows of adjacent product displays. Some of the product displays may be multi-sided, wherein products are displayed on the front, back, and/or sides of the product display. If product displays are multi-sided, a row of adjacent product displays may define one side of two aisles, wherein the row of product displays are in the center of the two aisles.

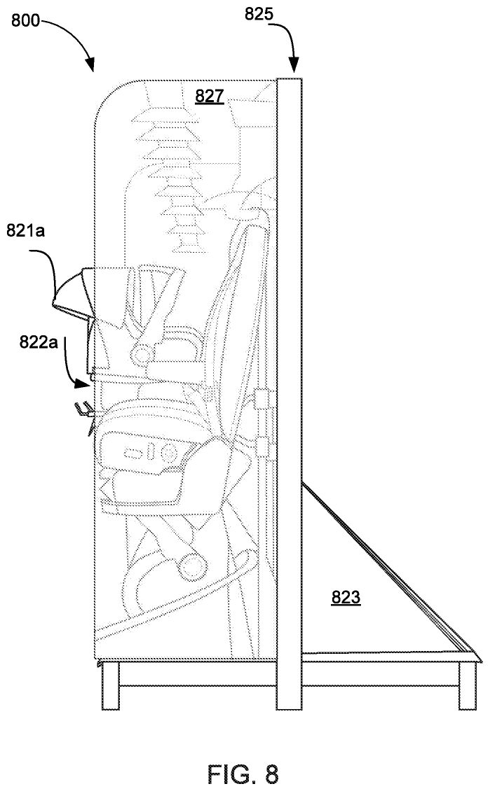

FIG. 8 illustrates an example of a two-sided product display configuration 800, which optimizes the management of products while allowing customers to interact with products in a meaningful way. FIG. 8 illustrates that base 823 may extend beyond load bearing back 825, such that product display configuration 800 has the capacity to display products that may be of the same or a different type facing in opposite directions.

In examples, product display configuration 800 includes one or more side panels, e.g. side panel 827. A side panel 827 may display an intended environment, such as an interior of a vehicle, for example, via one or more decals, static images, or dynamic images. In one example, a portion or all of a decal may cause a side panel to be semi-transparent such that some or all of product 821a is viewable through side panel 827. A portion or all of a decal may be opaque obviating some or all of one or more products from view, in some examples. The one or more decals may be configured to simulate one or more physical products 821a and 822a (e.g., rear facing infant seat system) as being located within a back seat of a car, for example.

FIG. 9 illustrates a straight-on view of example interactive product display configuration 900 as well as a block diagram of some of the computing features of exemplary interactive product display configuration 900. Any of the computing systems and methods disclosed herein are be part of any of the exemplary configurations disclosed herein.

In examples, display configuration 900 includes a rotatable platform 901 attached to an extendable arm (not shown) that is attached to crossbar 912. Example display configuration 900 may include side panels 927a-927n and one or more back panels 928 and 930.

In examples, back panel 930 may be a computer display. Any portion of back panels 928 and 930 and side panels 927a-927n may include computer displays. By way of example, a computer display may be at least one or more of, light emitting diode (LED) displays, liquid crystal displays (LCDs), plasma displays, smart displays, and/or any computer displays, and/or any combination thereof. Any part of one or more computer displays may or may not comprise touch screen components, if desired. Back panel 930 may be mounted (e.g., modularly) to one or more vertical posts (not shown) via one or more attachment mechanisms disclosed herein. In other examples, back panel 930 may be integrated with a load-bearing back panel that is attached to one or more vertical posts. For example, back panel 930 may be attached to one or more of right, left, and/or centrally located vertical posts of vertically extending load bearing back via a mounting bracket (e.g., television bracket)

FIG. 9 also includes an exemplary block diagram of some of the computing features of exemplary product display configuration system 900. In examples, product display configuration system 900 includes a computing device 931. Computing device 931 represents any device executing instructions (e.g., as application programs, operating system functionality, and/or both) to implement the operations and functionality as described herein. Examples of computing device 931 may include a mobile computing device or any other portable device. In some examples, the mobile computing device includes a mobile telephone, laptop, tablet, computing pad, netbook, gaming device, and/or portable media player. The computing device may also include less portable devices such as desktop personal computers, kiosks, tabletop devices, and/or the like. Additionally, the computing device may represent a group of processing units or other computing devices.

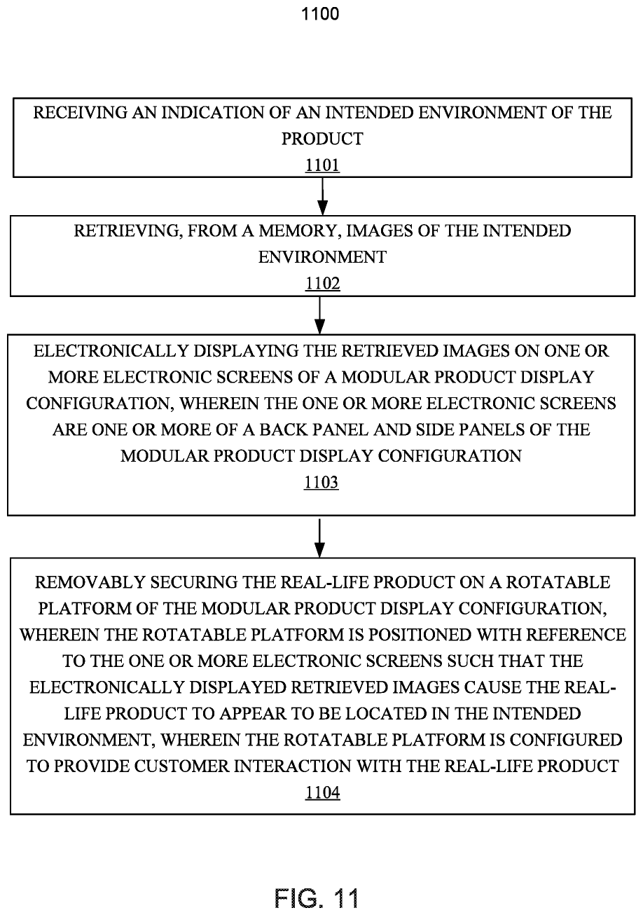

The computing device includes at least one processor 932 and at least one memory 939. The processor includes any quantity of processing units and is programmed to execute computer-executable instructions for implementing aspects of the disclosure. The instructions may be performed by the processor or by multiple processors within the computing device or performed by a processor external to the computing device. In some examples, the processor is programmed to execute instructions such as those illustrated in the figures (e.g., FIG. 11).

In some examples, computing device 931 includes a user interface component 933. User interface component 933 may include a graphics card for displaying data via a computer display, such as back panel 930, to the user 934 and receiving data via user input from the user 934. The user interface component 933 may also include computer-executable instructions (e.g., a driver) for operating the graphics card. Further, the user interface component 933 may include a display (e.g., a touch screen display or natural user interface) and/or computer-executable instructions (e.g., a driver) for operating one or more electronic computer display. The user interface component 933 may also include one or more of the following to provide data to the user or receive data from the user: speakers, a sound card, a camera, a microphone, a vibration motor, one or more accelerometers, a BLUETOOTH brand communication module, global positioning system (GPS) hardware, printer, and a photoreceptive light sensor. For example, the user 934 may input commands or manipulate data by interacting with the user interface component 933 in a particular way. In another example, the user 934 may input commands or manipulate data by providing a gesture detectable by the user interface component 933, such as a touch or tap of a touch screen display or natural user interface.

The computing device 931 further includes and/or couples to memory 939, which for examples may include one or more computer readable media. Memory 939 may be internal to the computing device, external to the computing device, or both. In some examples, the memory includes read-only memory and/or memory wired into an analog computing device.

Memory 939 may store data locally, for example, one or more computer-executable components. Exemplary computer-executable components include a product intended use environment simulation application, when executed by the processor 932 of computing device 931, cause the processor 932 to perform operations, including receiving user input (e.g., environment selections), during user interaction with one or more products 921-922 displayed by product display system 900.

Computer display components may include a graphics card for displaying data to the user. The user interface component 933 may also include computer-executable instructions (e.g., a driver) for operating the graphics card. Further, the user interface component 933 may include a computer display (e.g., a touch screen display or natural user interface) and/or computer-executable instructions (e.g., a driver) for operating the computer display. In examples, electronic computer display, such as back panel 930, may display visuals of an intended environment, such as the interior of a vehicle, simulating the view of real-life, physical products 921-922 as implemented within the intended environment, such as installed within a vehicle.

The computing device 931 may include transceiver (not shown), which may send and receive data, via communications network 935, to and from remote devices (which may include virtual servers) such as computing device 936 that includes one or more processor 937 and may access one or more database and/or memory store, such as, product data 938 (e.g., child safety seat data), user profile data 940, and/or intended use environment data 941 (e.g., vehicle data). In examples, one or more database and/or memory store may be combined or further delineated. Data may transmit via communications network 935. Transmitted data may include, but is not limited to, product data 938 including information about the displayed products 921-922, user profile data 940 related to user 934, and intended use environment data 941 associated with one or more selected intended use environments. In other examples, any of product data 938, user profile data 940, and intended use data 941 may be located at memory 939 local to computing device 931.

Based on product data, use profile data, and/or intended use environment data, computing device 931 may electronically display views of an intended use environment on one or more computer displays (e.g., back panel 930) in a manner that simulates products 921-922 as being located within an intended use environment. Further, based on product data, user profile data, and/or intended use environment data computing device 931 may display marketing and/or descriptive information about products 921-922 resting on rotatable platform 901.

In an example, products 921-922 may be an infant safety seat and corresponding base and the intended use environment may be the backseat or middle row seat of a vehicle. Based on infant safety seat system data, user profile data, and/or vehicle data, computing device 931 may electronically display the backseat or middle row seat of a selected vehicle on one or more computer displays (e.g., back panel 930) in a manner that simulates the actual infant safety seat and corresponding base (which is actually resting on rotatable platform 901) as being installed on a rear seat of the selected vehicle.

Further, based on infant safety seat system data, user profile data, and/or vehicle data, computing device 931 may display marketing and/or descriptive information about the actual infant safety seat and corresponding base, which is actually resting on rotatable platform 901, or other items, for example, compatible accessories, images related to one or more car seats the customer already owns as is indicated by user profile data, car seat information and/or images regarding car seats that processor 932 and/or processor 937 determines the user 934 may be interested in based on user profile data. If user profile data indicates seat color, then the seats may display as the same color as the customer owned vehicle.

A display implemented on or integrated with back panel 930 may display the seat backs of a back row or mid-row seat of the identified vehicle, and if desired, the back window. Generic locations may be displayed through the simulated window, if desired.

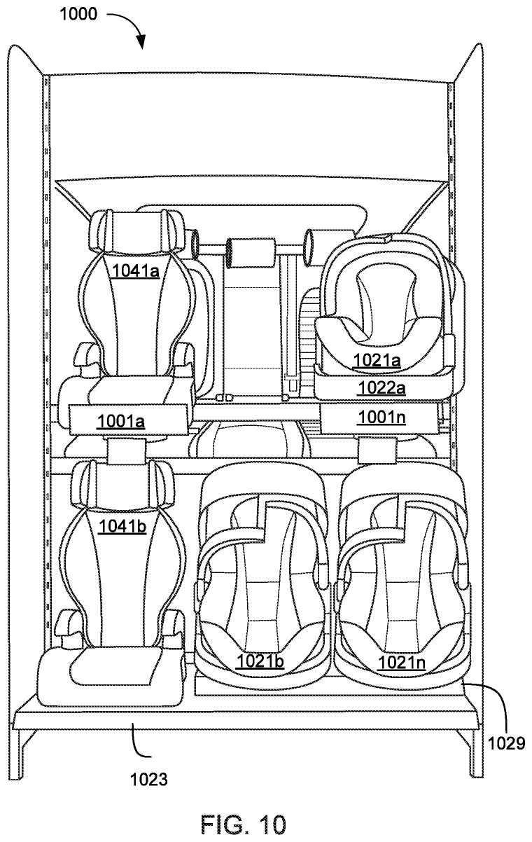

In examples, a modular interactive product display configuration provides for placement of one or more products in a variety of interactive configurations, such as product display configuration 1000 of FIG. 10, which is another example of an interactive modular display shelving system. Example product display configuration 1000 displays a variety of products on a plurality of rotatable platforms 1001a-1001n, such as example toddler seat 1041a and example infant safety seat 1021a and corresponding base 1022a. Example product display configuration 1000 also displays a variation of example toddler seat 1041b directly on base 1023, while displaying infant safety seats 1021b-1021n on shelf 1029.

FIG. 11 is an exemplary flow diagram illustrating example operations of displaying one or more products via an interactive product display configuration of any combination of the figures herein (e.g., FIGS. 1-10). In examples of method 1100, operation 1101 receives an indication of an intended environment (e.g., a make and model of a vehicle) of the real-life, physical product on display (e.g., child car seat). For example, the information may be received via user interface 933 wherein user 934 selects a vehicle from a choice of vehicles, user 934 identifies a vehicle by typing vehicle identification information into user interface 933 via a keyboard, for example, on a touchscreen, and/or processor 932 receives user identification information sent from a user device (e.g., a detected user's mobile device), along with an opt-in indication from the user, which the processor 932 uses to access user profile data 920 to determine the make and model of one or more of the customer owned vehicles.

Operation 1102 retrieves, from a memory, images of the intended environment. In an example, the images are a simulation of the inside of an indicated vehicle retrieved from a remote memory that stores a plurality of intended environments, such as, vehicle interiors, product compatible systems (e.g., strollers), and the like. Operation 1103 electronically displays the retrieved images on one or more electronic screens of a modular product display configuration. The one or more electronic screens are one or more of a back panel and side panels of the modular product display configuration. For example, the one or more electronic screens may be fastened to the vertically extending load bearing back of to the modular product display configuration, and the one or more electronic screens may display images of the interior of the indicated vehicle from the perspective of a person looking into the back seat.

In operation 1104, removably secures the real-life product on a rotatable platform of the modular product display configuration. In examples, the real-life product is a child safety seat. Further, the rotatable platform is positioned with reference to the one or more electronic screens such that the electronically displayed retrieved images cause the real-life product to appear to be located in the intended environment. For example, a real-life child seat may appear to be located on the seat of the interior of the indicated car. Further still, the rotatable platform is configured to provide customer interaction with the real-life product. For example, the rotatable platform allows a customer to practice latching the child safety seat to the platform, practice threading a simulated vehicle seat belt system through openings of the child safety seat, and more.

In some examples, some systems and methods for interactively displaying a product include a rotatable platform that comprises a mounting mechanism that removably secures at least one product being displayed by the rotatable platform and a rotator that rotates the rotatable platform. The example systems and methods further include at least one extendable arm that comprises at least one fastener that couples the extendable arm to the display shelving system and at least one fastener that couples the rotatable platform to the extendable arm in a configuration that allows the rotatable platform to rotate while coupled to the extendable arm. The example systems and methods further include at least one transitioning joint configured to allow the extendable arm to transition between a contracted position and an extended position, in response to a manual pull on the coupled rotatable platform. Further, the example systems and methods further include at least one transitioning joint configured to at least one transitioning joint configured to automatically transition the extendable arm between the extended position and the contracted position, in response to a manual release of the coupled rotatable platform.

In some examples, some systems and methods for interactively displaying a product receive an indication of an intended environment of the real-life product. Further, exemplary systems and methods include retrieving, from a memory, images of the intended environment. The example systems and methods further include electronically displaying the retrieved images on one or more electronic screens of a modular product display configuration, wherein the one or more electronic screens are one or more of a back panel and side panels of the modular product display configuration. Likewise, The example systems and methods further include removably securing the real-life product on a rotatable platform of the modular product display configuration, wherein the rotatable platform is positioned with reference to the one or more electronic screens such that the electronically displayed retrieved images cause the real-life product to appear to be located in the intended environment, wherein the rotatable platform is configured to provide customer interaction with the real-life product.

Alternatively, or in addition to the other examples described herein, examples include any combination of the following:
wherein the rotatable platform further comprises one or more anchors configured to simulate vehicle car seat anchors, and wherein the anchors receive latches of the product, wherein the product is a child car seat,
wherein the one or more anchors are configured to allow the rotatable platform to rotate while the latches of the product are coupled to the one or more anchors,
wherein the rotatable platform further comprises at least one seat belt system configured to simulate attachment of a child car seat to a vehicle seat via a vehicle seat belt system,
wherein the at least one seat belt system is configured to allow the rotatable platform to rotate while attached to the child car seat,
wherein the at least one seat belt system modularly attaches to the rotatable platform,
wherein the methods and systems further comprises at least one load bearing cross rail configured to modularly support the at least one extendable arm; a vertically extending load bearing back configured to modularly support at least: the at least one load bearing cross rail, at least one back panel that displays a simulation of an interior of a backseat of a vehicle, and side panels; and a load bearing base configured to support the vertically extending load bearing back,
wherein the vertically extending load bearing back is configured to modularly support the at least one load bearing cross rail via one or more receiving mechanisms that receive one or more protrusions of the at least one load bearing cross rail,
wherein the rotatable platform is configured to rotate a selectable number of degrees that is less than 360 degrees,
wherein the methods and systems further comprises at least one memory; at least one processor coupled to the memory; a transceiver coupled to the processor, wherein the transceiver receives an indication of a make and a model of a vehicle; and in response to the indicated make and model of the vehicle, one or more computer displays simulate the at least one product as being mounted inside the make and the model of the vehicle at least by electronically displaying an interior simulation of the make and the model of the vehicle at one or more of a back panel and side panels,
wherein the methods and systems further comprise receiving an indication of an intended environment of the real-life product,
wherein the methods and systems further comprise electronically displaying the retrieved images on one or more electronic screens of a modular product display configuration, wherein the one or more electronic screens are one or more of a back panel and side panels of the modular product display configuration,
wherein the methods and systems further comprises removably securing the real-life product on a rotatable platform of the modular product display configuration, wherein the rotatable platform is positioned with reference to the one or more electronic screens such that the electronically displayed retrieved images cause the real-life product to appear to be located in the intended environment, wherein the rotatable platform is configured to provide customer interaction with the real-life product,
wherein the real-life product is a child car seat, wherein the intended environment is a vehicle, wherein the indication indicates the make and the model of the vehicle, and wherein the retrieved images are images of an interior of the make and the model of the vehicle,
wherein the indication is received from at least one of: a user interface of the modular product display configuration, a wireless mobile device of a customer, and a remotely stored user profile,
wherein the retrieved images are retrieved from a remote memory storing images of a plurality of intended environments,
wherein the one or more electronic screens electronically displays one or more videos of an interior of a traveling vehicle determined to be the intended environment of the real-life product
wherein the retrieved images include annotations corresponding to features of the real-life product removably secured on the rotatable platform of the modular product display configuration,
wherein the systems and methods further comprise allowing manual rotation of the rotatable platform of the modular product display configuration,
wherein in response to a manual pull on the rotatable platform displaying the real-life product, transitioning an extendable arm between a contracted position and an extended position and
wherein in response to a manual release of the rotatable platform displaying the real-life product, automatically transitioning the extendable arm between the extended position and the contracted position.

In some examples, the operations illustrated in FIGS. 8 and 10 may be implemented as software instructions encoded on a computer readable medium, in hardware programmed or designed to perform the operations, or both. For example, aspects of the disclosure may be implemented as a system on a chip or other circuitry including a plurality of interconnected, electrically conductive elements. While the aspects of the disclosure have been described in terms of various examples with their associated operations, a person skilled in the art would appreciate that a combination of operations from any number of different examples is also within scope of the aspects of the disclosure.

### Exemplary Operating Environment

The examples and embodiments disclosed herein may be described in the general context of computer code or machine-useable instructions, including computer-executable instructions such as program components, being executed by a computer or other machine, such as a personal data assistant or other handheld device. Generally, program components including routines, programs, objects, components, data structures, and the like, refer to code that performs particular tasks, or implement particular abstract data types. The disclosed examples may be practiced in a variety of system configurations, including personal computers, laptops, smart phones, mobile tablets, hand-held devices, consumer electronics, specialty computing nodes, etc. The disclosed examples may also be practiced in distributed computing environments, where tasks are performed by remote-processing devices that are linked through a communications network.

A computing node includes a bus that directly or indirectly couples the following devices: memory, one or more processors, one or more presentation components, input/output (I/O) ports, I/O components, a power supply, and a network component. Computing node should not be interpreted as having any dependency or requirement related to any single component or combination of components illustrated therein. While computing node is depicted as a seemingly single device, multiple computing nodes may work together and share the depicted device resources. That is, one or more computer storage devices having computer-executable instructions stored thereon may perform operations disclosed herein. For example, memory may be distributed across multiple devices, processor(s) may provide housed on different devices, and so on.

Bus represents what may be one or more busses (such as an address bus, data bus, or a combination thereof). Also, processors have memory. Such is the nature of the art, an exemplary computing node that can be used in connection with one or more embodiments. Distinction is not made between such categories as “workstation,” “server,” “laptop,” “hand-held device,” etc., as all are contemplated within the scope of and the references herein to a “computing node” or a “computing device.”

Memory may include any of the computer-readable media discussed herein. Memory may be used to store and access instructions configured to carry out the various operations disclosed herein. In some examples, memory includes computer storage media in the form of volatile and/or nonvolatile memory, removable or non-removable memory, data disks in virtual environments, or a combination thereof

Processor(s) may include any quantity of processing units that read data from various entities, such as memory or I/O components. Specifically, processor(s) are programmed to execute computer-executable instructions for implementing aspects of the disclosure. The instructions may be performed by the processor, by multiple processors within the computing node, or by a processor external to the client computing node. In some examples, the processor(s) are programmed to execute instructions such as those illustrated in the flowcharts discussed below and depicted in the accompanying drawings. Moreover, in some examples, the processor(s) represent an implementation of analog techniques to perform the operations described herein. For example, the operations may be performed by an analog client computing node and/or a digital client computing node.

Ports allow computing node to be logically coupled to other devices including I/O components, some of which may be built in. Examples I/O components include, for example but without limitation, a microphone, keyboard, mouse, joystick, game pad, satellite dish, scanner, printer, wireless device, display device, speaker, printing component, vibrating component, etc. One skilled in the art will understand and appreciate that computer data may be presented in a number of ways, such as visually in a graphical user interface (GUI), audibly through speakers, wirelessly among multiple computing nodes, across a wired connection, or in other ways.

In some examples, the transceiver includes a network interface card and/or computer-executable instructions (e.g., a driver) for operating the network interface card. Communication between the computing node and other devices may occur using any protocol or mechanism over any wired or wireless connection. In some examples, the transceiver is operable to communicate data over public, private, or hybrid (public and private) using a transfer protocol, between devices wirelessly using short range communication technologies (e.g., near-field communication (NFC), Bluetooth® branded communications, or the like), or a combination thereof.

Although described in connection with an example computing node, examples of the disclosure are capable of implementation with numerous other general-purpose or special-purpose computing system environments, configurations, or devices. Examples of well-known computing systems, environments, and/or configurations that may be suitable for use with aspects of the disclosure include, but are not limited to, smart phones, mobile tablets, mobile computing nodes, personal computers, server computers, hand-held or laptop devices, multiprocessor systems, gaming consoles, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, virtual reality (VR) devices, holographic device, and the like. Such systems or devices may accept input from the user in any way, including from input devices such as a keyboard or pointing device, via gesture input, proximity input (such as by hovering), and/or via voice input.

Examples of the disclosure may be described in the general context of computer-executable instructions, such as program modules, executed by one or more computers or other devices in software, firmware, hardware, or a combination thereof The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number and/organization of such components or modules. For example, aspects of the disclosure are not limited to the specific computer-executable instructions or the specific components or modules illustrated in the figures and described herein. Other examples of the disclosure may include different computer-executable instructions or components having more or less functionality than illustrated and described herein. In examples involving a general-purpose computer, aspects of the disclosure transform the general-purpose computer into a special-purpose computing device or computing node when configured to execute the instructions described herein.

By way of example and not limitation, computer readable media comprise computer storage media and communication media. Computer storage media include volatile and nonvolatile, removable and non-removable memory implemented in any method or technology for storage of information such as computer readable instructions, data structures, program modules, or the like. Computer storage media are tangible and mutually exclusive to communication media. Computer storage media are implemented in hardware and exclude carrier waves and propagated signals. Computer storage media for purposes of this disclosure are not signals per se. Exemplary computer storage media include hard disks, flash drives, solid-state memory, phase change random-access memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium that can be used to store information for access by a computing device. In contrast, communication media typically embody computer readable instructions, data structures, program modules, or the like in a modulated data signal such as a carrier wave or other transport mechanism and include any information delivery media.

The examples illustrated and described herein as well as examples not specifically described herein but within the scope of aspects of the disclosure constitute an exemplary product display environment. For example, the elements illustrated in FIGS. 1-10, such as when caused or encoded to perform the operations illustrated in FIGS. 11 constitute exemplary means for receiving a rotatable platform onto an extendable arm that supports the rotatable platform while the extendable arm is in a contracted position, while the extendable arm is in an extended position, and while the extendable arm transitions between the extended position and the contracted position; exemplary means for securing a car seat by the rotatable platform, wherein the securing includes at least receiving one or more latches of the car seat onto one or more modular anchors of the rotatable platform, and wherein the rotatable platform fully rotates while the one or more latches of the car seat are attached to the one or more modular anchors of the rotatable platform, and wherein the rotatable platform fully rotates while the extendable arm is in the extended position; exemplary means for supporting the extendable arm by a back of the modular shelving system, wherein the back supports the extendable arm above a base of the modular shelving system; exemplary means for transitioning the extendable arm between the contracted position and the extended position in response to the rotatable platform being pulled away from a back of the modular shelving system; exemplary means for automatically transitioning the extendable arm between the extended position and the contracted position in response to the rotatable platform being released; exemplary means for receiving a tongue of a seat belt system of the rotatable platform into a buckle of the seat belt system, wherein the seat belt system simulates a vehicle seat belt system, wherein the seat belt system is modularly coupled to the rotatable platform; exemplary means for providing a 360 degree view of the secured car seat by allowing the rotatable platform to rotate 360 degrees in a plane parallel to the extendable arm while the car seat is secured by the rotatable platform and while the rotatable platform is supported by the extendable arm; exemplary means for the rotatable platform pivots around the extendable arm in a plane perpendicular to the extendable arm; exemplary means for receiving, by a processor of the modular shelving system, information indicating a make and model of a vehicle; exemplary means for and simulating the secured car seat as being mounted inside the make and model of the vehicle at least by displaying, via one or more computer displays, in an interior of the make and model of the vehicle in juxtaposition with the secured car seat

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation is within the scope of aspects of the disclosure.

When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of” The phrase “one or more of the following: A, B, and C” means “at least one of A and/or at least one of B and/or at least one of C.”

Having described aspects of the disclosure in detail, it will be understood that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

While the disclosure is susceptible to various modifications and alternative constructions, certain illustrated examples thereof are shown in the drawings and have been described above in detail. It should be understood, however, that there is no intention to limit the disclosure to the specific forms disclosed, but on the contrary, the intention is to cover all modifications, alternative constructions, and equivalents falling within the spirit and scope of the disclosure.

What is claimed is:

1. A display system comprising:
a rotatable platform comprising:
a mounting mechanism that removably secures at least one product being displayed by the rotatable platform, and
a rotator that rotates the rotatable platform;
at least one extendable arm comprising:
at least one fastener that couples the extendable arm to the display shelving system,
at least one fastener that couples the rotatable platform to the extendable arm in a configuration that allows the rotatable platform to rotate while coupled to the extendable arm,
at least one transitioning joint configured to:
in response to a manual pull on the coupled rotatable platform, allow the extendable arm to transition between a contracted position and an extended position; and
in response to a manual release of the coupled rotatable platform, automatically transition the extendable arm between the extended position and the contracted position.

2. The display system of claim 1, wherein the rotatable platform further comprises:
one or more anchors configured to simulate vehicle car seat anchors, and wherein the anchors receive latches of the product, wherein the product is a child car seat.

3. The display system of claim 2, wherein the one or more anchors are configured to allow the rotatable platform to rotate while the latches of the product are coupled to the one or more anchors.

4. The display system of claim 1, wherein the rotatable platform further comprises:
at least one seat belt system configured to simulate attachment of a child car seat to a vehicle seat via a vehicle seat belt system.

5. The display system of claim 4, wherein the at least one seat belt system is configured to allow the rotatable platform to rotate while attached to the child car seat.

6. The display system of claim 4, wherein the at least one seat belt system modularly attaches to the rotatable platform.

7. The display system of claim 1 further comprising:
at least one load bearing cross rail configured to modularly support the at least one extendable arm;
a vertically extending load bearing back configured to modularly support at least:
the at least one load bearing cross rail,
at least one back panel that displays a simulation of an interior of a backseat of a vehicle, and
side panels; and
a load bearing base configured to support the vertically extending load bearing back.

8. The display system of claim 7 wherein the vertically extending load bearing back is configured to modularly support the at least one load bearing cross rail via one or more receiving mechanisms that receive one or more protrusions of the at least one load bearing cross rail.

9. The display system of claim 1, wherein the rotatable platform is configured to rotate a selectable number of degrees that is less than 360 degrees.

10. The display system of claim 1 further comprising:
at least one memory;
at least one processor coupled to the memory;
a transceiver coupled to the processor, wherein the transceiver receives an indication of a make and a model of a vehicle; and
in response to the indicated make and model of the vehicle, one or more computer displays simulate the at least one product as being mounted inside the make and the model of the vehicle at least by electronically displaying an interior simulation of the make and the model of the vehicle at one or more of a back panel and side panels.

11. A method of displaying a tangible product in a simulation of an intended environment of the tangible product, the method comprising:
receiving an indication of an intended environment of the tangible product;
retrieving, from a memory, images of the intended environment;
electronically displaying the retrieved images on one or more electronic screens of a modular product display configuration, wherein the one or more electronic screens are one or more of a back panel and side panels of the modular product display configuration; and
removably securing the tangible product on a rotatable platform of the modular product display configuration, wherein the rotatable platform is positioned with reference to the one or more electronic screens such that the electronically displayed retrieved images cause the tangible product to appear to be located in the intended environment, wherein the rotatable platform is configured to provide physical interaction with the tangible product.

12. The method of claim 11, wherein the tangible product is a child safety seat, wherein the intended environment is a vehicle, wherein the indication indicates the make and the model of the vehicle, and wherein the retrieved images are images of an interior of the make and the model of the vehicle.

13. The method of claim 11, wherein the indication is received from at least one of:
a user interface of the modular product display configuration;
a wireless mobile device; and
a remotely stored user profile.

14. The method of claim 11, wherein the retrieved images are retrieved from a remote memory storing images of a plurality of intended environments.

15. The method of claim 11, wherein the one or more electronic screens electronically displays one or more videos of an interior of a traveling vehicle determined to be the intended environment of the tangible product.

16. The method of claim 11, wherein the retrieved images include annotations corresponding to features of the tangible product removably secured on the rotatable platform of the modular product display configuration.

17. The method of claim 11 further comprising:
allowing manual rotation of the rotatable platform of the modular product display configuration.

18. The method of claim 11 further comprising:
in response to a manual pull on the rotatable platform displaying the tangible product, transitioning an extendable arm between a contracted position and an extended position; and
in response to a manual release of the rotatable platform displaying the tangible product, automatically transitioning the extendable arm between the extended position and the contracted position.

19. A display apparatus, the display apparatus comprising:
a load bearing base configured to support a vertically extending load bearing back that is configured to modularly support at least:
one or more load bearing cross rails;
one or more back panels; and
one or more side panels;
the one or more load bearing cross rails being configured to modularly support at least one telescoping arm comprising:
at least one fastener that couples the telescoping arm to the one or more load bearing cross rails;
at least one fastener that couples a rotatable platform to the telescoping arm in a configuration that allows the rotatable platform to rotate while coupled to the telescoping arm;
at least one telescoping joint configured to:
in response to a manual pull on the coupled rotatable platform, transition the telescoping arm to between a contracted position and an extended position; and
in response to a manual release of the coupled rotatable platform, automatically transition the telescoping arm between the extended position and the contracted position; and
the rotatable platform comprises:
a mounting mechanism that removably secures at least one physical product being displayed by the rotatable platform, and
a rotator that rotates the rotatable platform.

20. The display apparatus of claim 19 further comprising:
at least one memory;
at least one processor coupled to the memory;
a transceiver coupled to the processor, wherein the transceiver receives an indication of an intended environment; and
in response to receiving the indicated intended environment, one or more computer displays that simulate the physical product as being implemented within the intended environment, the one or more computer displays coupled to or implemented as at least one or more of the back panels or the side panels and electronically displaying the intended environment.
